(19) United States
(12) Patent Application Publication
(10) Pub. No.: US 2005/0146884 A1
(43) Pub. Date: Jul. 7, 2005

(54) Light, particularly a warning light, for a vehicle

(75) Inventor: Ulrich Scheithauer, Erwitte (DE)

Correspondence Address: BIRCH STEWART KOLASCH & BIRCH, PO BOX 747, FALLS CHURCH, VA, 22040-0747, US

(73) Assignee: Goodrich Hella Aerospace Lighting Systems GmbH

(21) Appl. No.: 11/029,696

(22) Filed: Jan. 6, 2005

Related U.S. Application Data
(60) Provisional application No. 60/534,713, filed on Jan. 8, 2004.

(30) Foreign Application Priority Data
Jan. 7, 2004 (EP) 04 000 119.9

(51) Int. Cl. H01S 3/04

(52) U.S. Cl. 362/470

(57) ABSTRACT

The light (10), particularly warning light, for a vehicle, such as, for example, an airplane, is provided with at least one light-emitting diode (20) comprising a housing (22) with connecting elements (24) arranged thereon. Further, the light (10) comprises a heat sink (14) with which the housing (22) of the at least one light-emitting diode (20) is in heat-conducting contact. The at least one light-emitting diode (20) is pressed against the heat sink (14) by means of a pressing element (38) while a relative movement transverse to the pressing direction caused by different thermal expansion is maintained.

### BACKGROUND OF THE INVENTION

1. Field of the Invention

The invention relates to a light for a vehicle and particularly a warning light as is adapted to be mounted, e.g., to the outside of airplanes as an anti-collision light.

Because of their easy maintenance and long service life, light-emitting diodes are increasingly accepted in the construction of vehicles and in the construction of airplanes in particular. Their use in flash lights, e.g., as anti-collision lights in airplanes makes it necessary to effectively dissipate thermal power loss. To this end, it is advantageous when the light-emitting diodes are arranged on a heat sink to which they are thermally coupled in a tight manner. The thermal coupling of the light-emitting diodes to a heat sink via, e.g., heat-conducting pastes or adhesives, however, is limited with respect to the sufficient mechanical fixing on the heat sink, said limitations, in turn, restricting the use of the light-emitting diodes.

2. Description of Related Art

In US 2002/0149944 A1, a light for being mounted to the outside of an airplane is described. This light comprises a heat sink on which a ceramics substrate abuts which is equipped with light-emitting diodes.

US 2001/0122309 A1 describes an allround light that can be found, for example, as a warning light at airports or high buildings. The allround light is provided with several LEDs and comprises optical elements through which the light of the LEDs passes.

From German patent DE 199 26 561 A1, a projector is known which is particularly used as a reading light in airplane cabins. This projector is provided with a substrate on which a plurality of wired LEDs is arranged.

US 2003/01565416 A1 describes a light source with a reflector comprising a printed circuit board equipped with LEDs on a heat sink.

In WO 00/55925 A1, a light-emitting diode is described which is fastened on a substrate by means of a thermally conducting adhesive.

From U.S. Pat. No. 6,582,100 B1, an LED mounting system is known where a light-emitting diode is held pressingly in a spring-elastic manner via a pressing element against the printed circuit board on which the light-emitting diode is arranged.

WO 02/49917 A1 discloses a strobe light which uses light-emitting diodes arranged about the circumference of an electrically insulative, thermally conductive disc to form an LED light ring.

From EP 1 334 870 A2, there is known a flashing optical indicator device comprising a plurality of light sources arranged on a common carrier.

U.S. Pat. No. 6,376,949 B1 discloses an LED utility lamp also comprising a plurality of LED devices mounted on a common carrier.

WO 01/14789 A1 discloses an obstruction lamp which includes a plurality of LEDs connected in series and mounted on a common carrier.

### SUMMARY OF THE INVENTION

It is an object of the invention to provide a light with at least one light-emitting diode the thermal coupling of which to a heat sink is improved and which simultaneously ensures a mechanically sufficient fixing thereof.

In order to solve this object, the invention suggests a light, particularly a warning light, for a vehicle, such as, for example, an airplane, the light being provided with
at least one light-emitting diode comprising a housing with connecting elements arranged thereon, and
a heat sink with which the housing of the at least one light-emitting diode is in heat-conducting contact.

With this light, it is provided, according to the invention,
that the at least one light-emitting diode is pressed against the heat sink by means of a pressing element while a relative movement transverse to the pressing direction caused by different thermal expansion is maintained.

According to the invention, the at least one light-emitting diode is mechanically pressed against the heat sink by means of a pressing element in a pressing direction determined by the effect of the pressing force. The advantage of this mechanical pressing of the light-emitting diode against the heat sink consists in that a relative movement of heat sink and light-emitting diode transverse to the pressing direction, caused by a different thermal expansion, for example, is still given in spite of the pressing effect. Especially in this aspect, the solution suggested according to the invention is advantageous compared with glueing the housing of the light-emitting diode to the heat sink by means of a thermally conducting adhesive, for example.

Preferably, the pressing element has an elastic configuration which is realized by a corresponding material selection and/or a corresponding constructive configuration. The pressing element abuts on the housing of the light-emitting diode. Apart from connecting elements for the electric contacting, the housing also comprises a light exit area from which the radiation produced by the light-emitting diode emerges. The pressing element engages the housing outside the light exit area so that the light efficiency of the light-emitting diode is not influenced in a negative manner. Depending on the configuration and mechanical contacting of the pressing element, the latter may be reflective in areas in which radiation produced by the light-emitting diode impinges onto the pressing element. The dissipation of dissipation heat of the light-emitting diode is further improved when the pressing element consists of a heat-conducting and/or heat-radiating material such as, for example, metal. (with a black coating, if necessary).

To further increase the heat dissipation efficiency, it is advantageous when a layer of heat-conducting material is arranged between the heat sink and the housing, which permits shearing forces between the heat sink and the housing of the light-emitting diode. This means that the layer of heat-conducting material is deformable in this respect like heat-conducting pastes, elastic or plastic thermally conducting adhesives or other soft thermally conducting materials are. Preferably, permanently elastic thermal conducting pastes are used as a relatively thin layer.

The electric contacting of the at least one light-emitting diode is preferably effected via a printed circuit board arranged between the light-emitting diode and the heat sink and extending continuously below the light-emitting diode. Suitably, the printed circuit board is at least sectionally flexible. By the pressing element=s pressing against the housing of the light-emitting diode, it indirectly presses the flexible printed circuit board against the heat sink so that a good thermal contact between housing and heat sink is still given. The printed circuit board may be configured as a rigid-flex printed circuit board, the light-emitting diode being arranged in a flexible and thus thin area of the printed circuit board. Preferably, the printed circuit board as a whole has a flexible configuration, i.e., it does not have any rigid areas. Such printed circuit boards are suitable for being laid around a heat sink in the way of a band, said heat sink acting as a carrier and thermal dissipation mass for the light-emitting diode(s).

In spite of using an (at least sectionally flexible) printed circuit board for electrically contacting the light-emitting diode, the printed circuit board does not necessarily have to extend between the housing of the light-emitting diode and the heat sink. The printed circuit board may have a recess in the region of the housing, for example, so that the housing has direct contact to the heat sink. The latter either has abutment surfaces raised by the thickness of the printed circuit board or the underside of the housing of the light-emitting diode is rather in alignment with the underside of the printed circuit board. A layer of heat-conducting material may be arranged between the housing of the light-emitting diode and the heat sink.

In lights where the light is radiated within a certain azimuth angle range as it is the case with anti-collision lights, for example, which, among other things, radiate light over 360□ with respect to a horizontal plane, the heat sink is preferably configured as a rotationally symmetric body at the peripheral surface of which several light-emitting diodes are arranged. The light exit areas of the housings of these light-emitting diodes face away from the peripheral surface of the heat sink and are thus located on that side of the housing against which the pressing force of the pressing element(s) acts. When the light has such a structure, it is advantageous if the pressing element for all light-emitting diodes is configured as a tensioning element abutting on the outside of the housing of the at least one light-emitting diode facing away from the heat sink outside the light exit area of the housing arranged at this outer surface. Thus, it is possible, for example, to form a common tensioning element in the form of a wire configured as a spring, a flat band or the like narrow element extending laterally with respect to the light exit areas of all housings of the light-emitting diodes over the respective outer surfaces thereof and abutting thereon. At both sides of the light exit areas of the housings, two of these tensioning elements are suitably provided. It is constructively simpler and particularly more optimized for mounting, however, if the tensioning element is configured as a tightening strap extending almost over the entire width of the outer surfaces of the housings of the light-emitting diodes, which have the light exit areas, and comprising recesses aligned with the light exit areas of the housings.

Configuring the pressing element in the form of a tensioning element has the advantage that the light dispersion direction of the light-emitting diodes is not impaired by the pressing element. The opposite ends of the tensioning element can be fastened to the heat sink, for example, so that the tensioning element encloses the individual light-emitting diodes between itself and the heat sink outside its two ends. It is even more suitable, however, when the two ends of the tensioning element or tightening strap are directly or indirectly and preferably releasably connected with each other and the tensioning element thus encloses the light-emitting diodes between itself and the heat sink over its entire length, i.e., in the region of its two connected ends as well. Thus, a heat sink can be realized which carries light-emitting diodes radiating light over 360□ and against which the housings of the light-emitting diodes are held pressingly. Further, the heat sink itself does not need to have any fastening elements for the tensioning element which, besides the afore-described advantage, simplifies its construction.

A pressing of surfaces, i.e., a two-dimensional contact is advantageous so that the heat transport between the housing of the light-emitting diode and the heat sink is effected as effectively as possible. This means that the two opposite surfaces of heat sink and light-emitting diode housing should match each other. Since it is advantageous in terms of production to produce housings for light-emitting diodes with plane abutment surfaces, it is suitable when the heat sink-comprises sectionally plane abutment surface areas (facets) on its peripheral surface. Within these plane abutment surface areas, one or more light-emitting diode housings are respectively arranged.

### BRIEF DESCRIPTION OF THE DRAWING

Hereinafter, the invention is explained in detail with reference to the drawing. In the Figures:

FIG. 1 is a side view of an anti-collision light with several rows of light-emitting diodes arranged next to each other, said rows being arranged above one another and extending over 360°,

FIG. 2 is a sectional view along line II-II of FIG. 1, and

FIG. 3 is a plan view of the heat sink with surrounding light-emitting diodes in the direction of the arrow III of FIG. 1.

### DETAILED DESCRIPTION OF A PREFERRED EMBODIMENT OF THE INVENTION

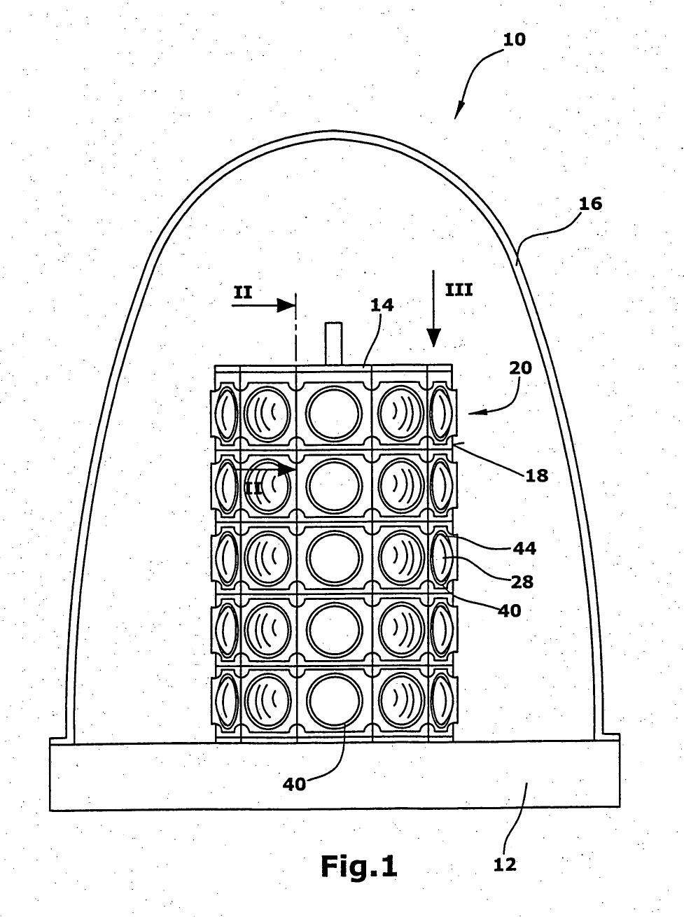

FIG. 1 shows a light 10 in side view, said light being configured as a warning light or anti-collision light in this embodiment and comprising a base body 12 with a substantially rotationally symmetric heat sink 14 arranged thereon and a dome-like transparent light cover 16. On the outside 18 of the heat sink 14, there is a plurality of light-emitting diodes 20 that are arranged in horizontal rows next to each other in this embodiment, several rows of such light-emitting diodes being arranged above one another.

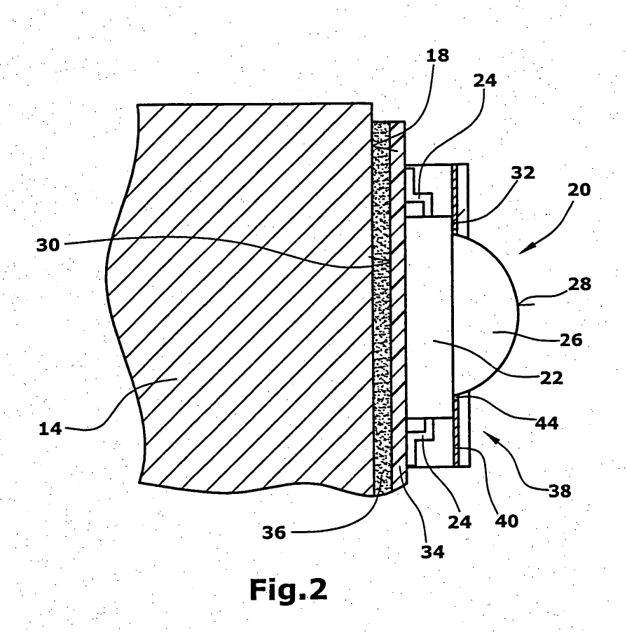

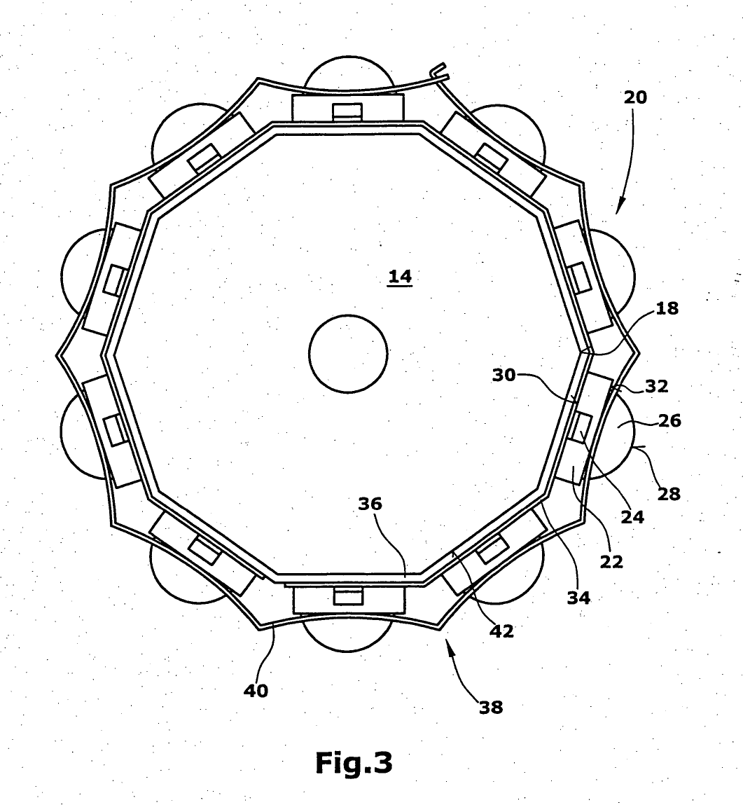

As can be seen best in FIGS. 2 and 3, each light-emitting diode has a housing 22 from which two connecting elements 24 project. Further, the housing 22 is provided with a spherical optical element 26 the outside of which defines the light exit area 28 of the housing 22. The housing 22 comprises an underside 30 facing the outside 18 of the heat sink 14 as well as an outside 32 opposite thereto.

The electric connecting elements 24 are connected with (non-illustrated) electric strip conductors of a flexible printed circuit board 34 which is laid about the outside of the heat sink 14. This flexible printed circuit board 34 is thermally coupled with the heat sink 14 via a heat-conducting material layer 36 in the form of, e.g., a heat-conducting paste or an elastic or plastic heat-conducting adhesive.

Via this thermal coupling, dissipation heat produced by the light-emitting diodes 20 during their operation is dissipated to the heat sink 14. As has been found out, the simple (touch) contact between the housings 22 of the light-emitting diodes 20 and the heat sink 14 where, if necessary, a heat-conducting material layer 36 is interposed, is not sufficient particularly with the presently available high-efficiency light-emitting diodes with a power output of a few watt.

Therefore, the light-emitting diodes 20 in the light 10 described here and shown in the drawing are mechanically pressed against the heat sink 14 by means of spring-elastic pressing elements 38. In this embodiment, the pressing elements are configured as tightening straps 40 abutting on the outsides 32 of the light-emitting diode housing 22 and being configured so as to extend circumferentially. The tightening straps 40 comprise spring steel, for example, and consist of individual sections 41 bent concavely away from the heat sink 14, the number of which is equal to the number of the light-emitting diode housings 22 per row. The ends 42 of each tightening strap 40 are directly or indirectly connected with each other. Each tightening strap 40 surrounds a horizontal row of light-emitting diodes 20 from outside and presses the light-emitting diode housings 22 against plane abutment surface areas 44 of the outside 18 of the heat sink 14. Each tightening strap 40 has a respective recess 44 in its sections 41 which is in alignment with the light exit areas 28 of the light-emitting diode housings 22. The tensioning bands 40 are elastic which, as described above and illustrated in the drawing, can be realized by a corresponding constructive configuration of the straps or by the material thereof. The constructive configuration may also refer to the (non-illustrated) closure of the tightening straps 40. The tightening straps 40 serve to dissipate heat both directly and indirectly. The indirect heat dissipation effect of the tightening straps 40 is based on that the tightening straps 40 press the housings 22 against the heat sink 14 and thus improve the thermal contact of the housings 22 with the heat sink 14. On the other hand, the direct cooling effect of the tightening straps 40 applies to that they directly abut on the housings 22 of the light-emitting diodes 20 and thus dissipate heat from the housings 22 into the environment.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. Light, particularly warning light, for a vehicle, such as, for example, an airplane, comprising
at least one light-emitting diode comprising a housing with connecting elements arranged thereon, and
a heat sink with which the housing of the at least one light-emitting diode is in heat-conducting contact,
characterized in
that the at least one light-emitting diode is pressed against the heat sink by means of a pressing element while a relative movement transverse to the pressing direction caused by different thermal expansion is maintained.

2. Light according to claim 1, characterized in that a deformable heat-conducting material layer is arranged between the heat sink and the housing of the at least one light-emitting diode.

3. Light according to claim 1, characterized in that the at least one light-emitting diode is electrically contacted at an at least sectionally flexible printed circuit board and that the pressing element presses the housing of the at least one light-emitting diode against the printed circuit board and thus the latter against the heat sink.

4. Light according to claim 1, characterized in that the pressing element is configured as a tensioning element abutting on the outside of the housing of the at least one light-emitting diode, which faces away from the heat sink.

5. Light according to claim 1, characterized in that the pressing element is reflective at least in those areas within which light emerging from the housing of the at least one light-emitting diode impinges onto the pressing element.

6. Light according to claim 1, characterized in that the tensioning element is configured as a tightening strap comprising a recess being in alignment with a light exit area of the housing of the at least one light-emitting diode.

7. Light according to claim 1, characterized in that the pressing element is supported against the heat sink.

8. Light according to claim 1, characterized in that the heat sink comprises an outer surface with at least one plane abutment surface area against which the housing of the at least one light-emitting diode is held pressingly by the pressing element.

9. Light according to claim 1, characterized in that several light-emitting diodes are provided.

10. Light according to claim 8 and 9, characterized in that at least two light-emitting diodes are held pressingly against a common plane abutment surface area of the heat sink.

11. Light according to claim 8 and 9, characterized in that the heat sink has several plane abutment surface areas arranged successively in the circumferential direction thereof, and that the housing of at least one light-emitting diode is held pressingly against each abutment surface area, respectively.

12. Light according to claim 11, characterized in that the pressing element is configured as a circumferentially extending tensioning element.

13. Light according to claim 12, characterized in that the tensioning element comprises ends opposite to each other which are preferably adapted to be releasably connected to each other.

14. Light according to claim 1, characterized in that the pressing element comprises a heat-conducting material.
